(19) United States
(12) Patent Application Publication
(10) Pub. No.: US 2009/0025287 A1
(43) Pub. Date: Jan. 29, 2009

(54) PLANT GROWING SYSTEM

(76) Inventor: Yu Mei Lee, Woodside, NY (US)

Correspondence Address: ADVANTIA LAW GROUP, 9035 SOUTH 1300 EAST, SUITE 200, SANDY, UT, 84094, US

(21) Appl. No.: 11/782,854

(22) Filed: Jul. 25, 2007

(51) Int. Cl. A01G 9/24; A01G 9/00

(52) U.S. Cl. 47/17

(57) ABSTRACT

A plant growing system for growing plants. The system includes a control module, an atmospheric condition sensor module, an atmospheric condition response module, a nutrient concentration sensor probe module, and a nutrient pump module. The atmospheric condition sensor module may include: a photo sensor, a humidity sensor, and an air temperature sensor. The atmospheric condition response module may include: a lighting module, a humidifying module, a dehumidifying module, a heating module, and a cooling module. A nutrient level sensor module and a communication module are configured to communicate a detected level of water. The communication module comprises an audio communication module and a graphical user interface module. The nutrient pump module comprises: a first nutrient reservoir, a nutrient pump, a first nutrient dispersion member, a second nutrient reservoir, and a second nutrient dispersion member. There is a power module comprising a solar panel which is configured to provide energy.

### BACKGROUND OF THE INVENTION

1. Field of the Invention

The present invention relates to a plant growing system, and more specifically to an automated plant growing system.

2. Description of the Related Art

Plants are often grown indoors to enhance indoor environments. In addition, plants are often grown indoors when outdoor environments do not allow for plant growth. For example, outdoor conditions such as below-freezing temperatures and drought often do not allow for plant growth.

Generally, most plants need food, water, and light for growth. However, the growing requirements of plants may vary from species to species. Also, some plants are temperamental and may have different requirements at different times depending on various environmental factors, thereby needing constant care and maintenance. For instance, many plants are easily damaged by inappropriate amounts of nutrients, moisture, and/or light.

In particular, it is often difficult to provide appropriate amounts of nutrients, moisture, and light when plants are removed from their natural environments and placed indoors. Additionally, many indoor plants cannot be left unattended for long periods of time without causing significant damage to the plant. Furthermore, it is often difficult and/or expensive to replace plants which are rare and exotic.

Accordingly, there exists a need for a plant growing system which monitors plant conditions and automatically provides appropriate growth requirements of a plant based on the monitored conditions. Some improvements have been made in the field. Examples of references related to the present invention are described below, and the supported teachings of each reference are incorporated by reference herein:

U.S. Patent Application Publication No. 2002/0184820, by Mauney, discloses a substantially automated sealable, soil less plant growing apparatus for maximizing plant growth by maximizing light and CO₂ consumption by the plant and controlling the plants reproductive cycle by controlling its environment. A light timer controls the grow light and can stimulate a photo period. A pump timer can control the watering cycle and drainage switch. The plant growing environment can be fully, partially, or uncontrolled in conditions such as light, temperature, humidity, irrigation, and atmosphere.

U.S. Pat. No. 4,462,183, issued to Bruhm, discloses a window garden that is comprised of a fixed frame secured to the perimeter of a window opening in a dwelling house and has an outwardly moveable sash frame fixed and hingeable to the top edge of the window frame. A pair of transparent domed members having dead air or a vacuum there between, that forms a plant displayable enclosure in the window which is protected from frost and obtains maximum winter sunlight when oriented in a southern exposure of a dwelling. Means such as nylon or polypropylene screen material are provided between said fixed and moveable frames to exclude insects when the domed sash frame is moveable outward to allow air to enter there between.

U.S. Pat. No. 6,212,823, issued to Oram et al., discloses a system for simulating the lighting cycle of the sun obtains a set of inflection points on a solar lighting cycle and also obtains the annual minimum sunlight value for a location at a predetermined latitude; reconstructs the daily and yearly solar cycle based about the set of inflection point and the minimum yearly value; determines the lighting period based upon the daily and yearly cycles; activates a lighting device for the determined lighting period; transmits a series of electrical pulses to the soil and receives a return signal from the soil, the return signal indicative of the conductivity of the soil; determines whether the conductivity indicates whether the soil has an adequate moisture level; and activates an LED to indicate the soil does no have an adequate moisture level.

U.S. Pat. No. 4,051,628, issued to Knapp et al., discloses the present invention relates to an apparatus for dispensing plant nutrients to a growing medium, such as soil, sand or the like, the apparatus being effective to transfer to the medium over protracted periods of time doses of nutriments at a rate which is a function essentially solely of the amount of water added to the growing medium at each watering. Broadly stated, the invention relates to a container which preferably includes a probe adapted to be inserted sufficiently below the surface of the growing medium to prevent evaporation. The container is sealed except for a dispensing aperture or apertures in the probe of critical size, larger than a capillary. The apparatus is characterized by its being filled with a hydrophilic gel, within which gel there has been dissolved a soluble nutriment component, preferably in saturation quantities. The gel may contain an inert soluble dye to signal the exhaustion of the active products.

U.S. Pat. No. 6,000,170, issued to Davis, discloses an apparatus and a method for controlling the amount of solar energy and heat transferred into and out of a building or other structure through a glazed opening using a system of pneumatically actuated, reflective shutters. The air discharged from the blower flows through a venturi. The venturi communicates with a system of inflatable, reflective shutter elements. A control valve downstream from the venturi regulates airflow through the venturi. A photoelectric sensing element is installed at the level of the growing plants. The electric current generated by the sensing element is proportional to the intensity of the sunlight entering through the glazed roof. The control valve is operated by an electrical control means which responds to the electric current generated by the photoelectric sensing element. When the intensity of the sunlight exceeds the desired intensity, air flowing through the venturi is restricted and redirected in inflate the inflatable, reflective shutter elements to the degree necessary to obtain the desired intensity of sunlight. The inflatable shutter elements have a specular reflective surface so that sunlight is reflected from the shutter elements without a change in wavelength thus permitting the reflected sunlight to exit through the glazed surface. When the intensity of sunlight is less than the desired intensity, air flow through the venturi is increased thereby creating a low pressure in the venturi and evacuating air from the inflatable reflective shutter elements thus causing the shutter elements to collapse to a minimal thickness and block only a negligible amount of sunlight. The shutter elements are mounted close to the glazed surface in such a manner as conform to the shape of the glazed roof and to provide an insulating barrier when fully inflated thus restricting the flow of heat through the glazed surface. When fully deflated, the reflective shutter elements can be inclined to reflect the sunlight entering at a relatively low angle of incidence in a desired direction to increase the intensity of sunlight at desired locations within the structure.

The inventions heretofore known suffer from a number of disadvantages, which include: being difficult to use, being ineffective, being inefficient, being expensive, being difficult to install, not being automatic, and/or not being all-in-one.

What is needed is a plant growing system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available plant growing systems. Accordingly, the present invention has been developed to provide an efficient, easy to use, compact and versatile plant growing system.

In one embodiment of the invention, there may be a plant growing system for growing plants that may include a control module. The control module may be configured to provide control of the plant growing system. An atmospheric condition sensor module may be in communication with the control module, and/or may be configured to sense an atmospheric condition of the plant growing system. An atmospheric condition response module may be in communication with the control module, and/or in communication with the atmospheric condition sensor module. Furthermore, the atmospheric condition response module may be configured to provide a response to an atmospheric condition. A nutrient concentration sensor probe module may be in communication with the control module and/or may be configured to detect a nutrient concentration of soil of the plant growing system. In addition, a nutrient pump module may be in communication with the control module and/or may be in communication with the nutrient concentration sensor probe module. The nutrient pump module may be configured to pump a nutrient into soil of a plant in the plant growing system.

The atmospheric condition sensor module of the plant growing system may include of one or more sensors selected from the group consisting of: a photo sensor, a humidity sensor, and/or an air temperature sensor. The atmospheric condition response module of the plant growing system may include of one or more modules selected from the group consisting of: a lighting module, a humidifying module, a dehumidifying module, a heating module, and/or a cooling module. The heating module of the atmospheric condition response module may include a heating pad. The cooling module of the atmospheric response module may include a cooling fan.

The plant growing system may further include a nutrient level sensor module that may be in communication with control module and/or in communication with the pump module. The nutrient level sensor module may be configured to sense a level of nutrients of the plant growing system. A communication module may be in communication with the control module and/or in communication with the nutrient level sensor module. The communication module may be configured to communicate a detected level of nutrients determined by the nutrient level sensor module. Moreover, the communication module may include an audio communication module. The audio communication module may be configured to audibly communicate a detected level of nutrients determined by the nutrient level sensor module. Furthermore, the communication module may include a graphical user interface module that may be configured to provide a graphical user interface for communication. The graphical user interface module may include an image of an animated plant configured to communicate information to a user. Data from the nutrient level sensor module may be reflected in an appearance of the animated plant, and may communicate a condition of a plant.

Also, the plant growing system may include a nutrient pump module that may include of a first nutrient reservoir that may be configured to store a first nutrient. The nutrient pump may be in fluid communication with the first nutrient reservoir and/or may be configured to pump a first nutrient to a plant in the plant growing system. A first nutrient dispersion member may be in fluid communication with the nutrient pump and/or may be configured to disperse the first nutrient from the first nutrient reservoir to a plant. The nutrient pump module may further include a second nutrient reservoir that may be in fluid communication with the nutrient pump. The second nutrient reservoir may be configured to store a second nutrient. A second nutrient dispersion member may be in fluid communication with the nutrient pump and/or may be configured to disperse the second nutrient from the second nutrient reservoir to a plant.

Additionally, the plant growing system may include a power module that may be in communication with the control module and/or may be configured to store and/or provide energy. The power module of the plant growing system may include a solar panel. A plant growing system housing may be configured to house the plant growing system. A bracket member may be coupled to the plant growing system housing and/or may be coupleable to a window frame. The plant growing system housing and/or bracket member may be configured to secure the plant growing system housing to a window frame.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not therefore to be considered to be limiting of its scope, the invention will be described and explained with additional specificity and detail through the use of the accompanying drawing(s), in which:

FIG. 1 illustrates a block diagram of a plant growing system, according to one embodiment of the invention;

FIG. 2 illustrates a block diagram of an atmospheric condition sensor module of a plant growing system, according to one embodiment of the invention;

FIG. 3 illustrates a block diagram of an atmospheric condition response module of a plant growing system, according to one embodiment of the invention;

FIG. 4 illustrates a block diagram of a communication module of a plant growing system, according to one embodiment of the invention;

FIG. 5 illustrates a block diagram of a power module of a plant growing system, according to one embodiment of the invention;

FIG. 6 illustrates a block diagram of a nutrient pump module of a plant growing system, according to one embodiment of the invention;

FIG. 7 is a front elevational view of a plant growing system, according to one embodiment of the invention;

FIG. 8 is a side cross-sectional view of a plant growing system, according to one embodiment of the invention;

FIG. 9 is a rear cross-sectional view of a plant growing system, according to one embodiment of the invention; and

FIG. 10 is a front elevational view of a plant growing system, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

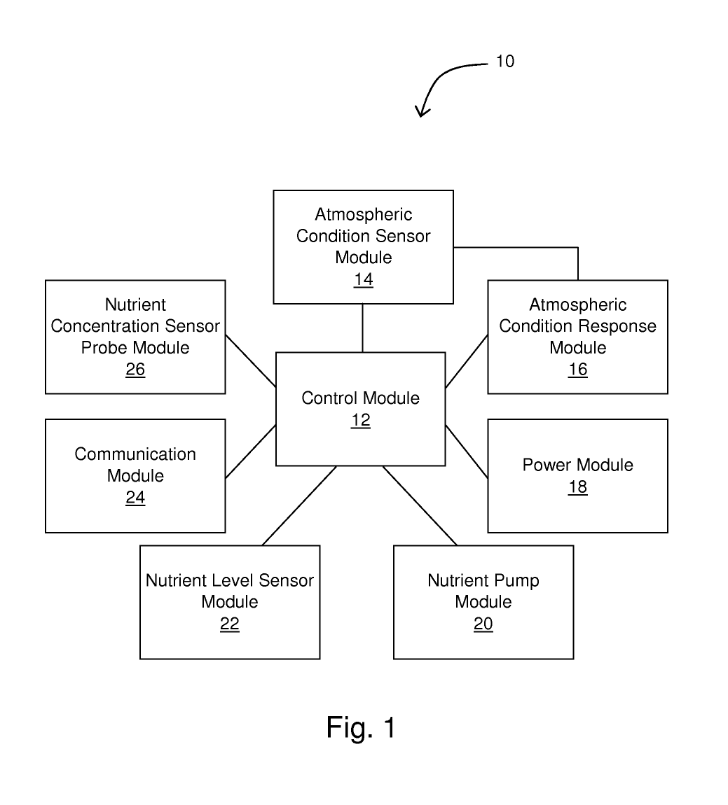

FIG. 1 illustrates a block diagram of a plant growing system. The diagram illustrates a control module 12 in electronic communication with an atmospheric condition sensor module 14 to sense atmospheric conditions surrounding a plant 80. The control module 12 is in electronic communication with an atmospheric condition response module 16 and the atmospheric condition sensor module 14. One non-limiting example of a control module may be a Honeywell Control Module manufactured by Honeywell Sensing and Controls, Inc., 11 West Spring Street, Freeport, Ill. 61032. The atmospheric condition response module 16 is configured to provide a response, to an atmospheric condition communicated from the atmospheric condition sensor module 14. There is a power module 18 in electric communication with the control module 12 which is configured to provide power, electro motive force, to the plant growing system 10. An example of a power module may include but is not limited to a power module as described in U.S. Pat. No. 6,882,538, issued to Frisch, which is incorporated by reference for its supporting teachings herein. A nutrient concentration sensor probe module 26 is configured to be in electronic communication with the control module 12 and is configured to detect a nutrient concentration in soil surrounding a plant 80. One non-limiting example of a nutrient concentration sensor probe module is a soil moisture sensor as described in U.S. Pat. No. 7,135,871, issued to Pelletier, which is incorporated by reference for its supported teachings herein. A nutrient pump module 20 is in fluid communication with the control module 12 and with the nutrient concentration sensor probe module 26. The nutrient pump 20 is configured to pump a nutrient to a plant 80 in the plant growing system 10. One non-limiting example of a nutrient pump is a fuel pump as described in U.S. Pat. No. 6,158,975, issued to Dill et al., which is incorporated by reference for its supported teachings herein. A nutrient level sensor module 22 is in electronic communication with the control module 12. One example of a nutrient level sensor module may include, but is not limited to; a water level sensor such as described in U.S. Pat. No. 6,810,732, issued to Shon, which is incorporated by reference for its supported teachings herein. A communication module 24 is in electronic communication with the control module 12. One non-limiting example of a communication module may be a data communication module such as described in U.S. Pat. No. 4,689,801, issued to Nurczyk et al., which is incorporated by reference for its supported teachings herein.

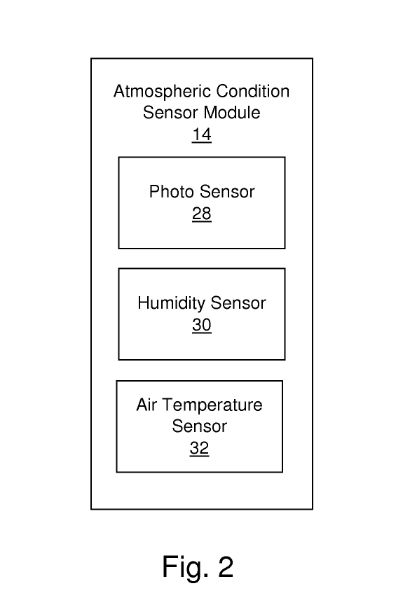

FIG. 2 illustrates a block diagram of an atmospheric condition sensor module 14 of the plant growing system 10. The diagram illustrates an atmospheric condition sensor module 14 which is comprised of one or more sensors selected from a group of sensors including: a photo sensor 28, a humidity sensor 30, and/or an air temperature sensor 32. One non-limiting example of an atmospheric condition sensor module is described in U.S. Application Publication No. 2005/0288038, by Kim, which is incorporated by reference for its supported teachings herein. As illustrated, the group of sensors includes a photo sensor 28, a humidity sensor 30, and/or an air temperature sensor 32, to ascertain and communicate atmospheric conditions existing within the plant growing system 10. An example of a photo sensor may include, but is not limited to, a UV light sensor as described in U.S. Application Publication No. 2007/0131869, by Cole et al., which is incorporated by reference for its supported teachings herein. One non-limiting example of a humidity sensor is described in U.S. Pat. No. 6,126,312, issued to Sakai et al., which is incorporated by reference for its supported teachings herein. One example of an air temperature sensor may include, but is not limited to, an air temperature sensor, such as described in U.S. Pat. No. 5,449,234, issued to Gipp et al., which is incorporated by reference for its supported teachings herein.

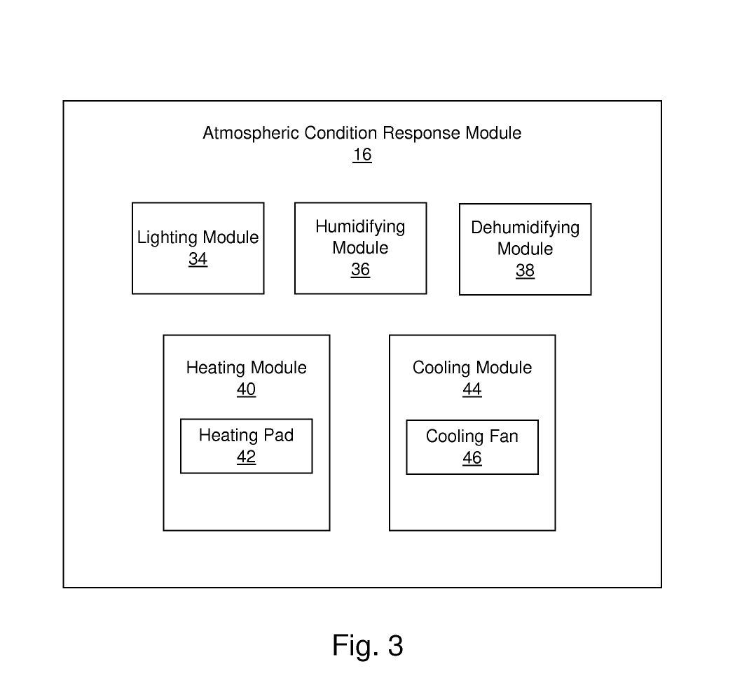

FIG. 3 illustrates a block diagram of an atmospheric condition response module 16. As shown, the atmospheric condition response module 16 is comprised of a lighting module 34, a humidifying module 36, and a dehumidifying module 38. One non-limiting example of an atmospheric condition response module is described in U.S. Application Publication No. 2005/0288038, by Kim, which is incorporated by reference for its supported teachings herein. Also illustrated, the atmospheric condition response module 16 further includes a heating module 40 and a cooling module 44. The illustrated heating module 40 includes a heating pad 42. The illustrated cooling module 44 includes a cooling fan 46. One non-limiting example of a heating pad is described in U.S. Application Publication No. 2004/0065659, by Tse, which is incorporated by reference for its supported teachings herein. One example of a cooling fan may include, but is not limited to, a cooling fan, such as described in U.S. Pat. No. 6,400,049 issued to Lai, which is incorporated by reference for its supported teachings herein.

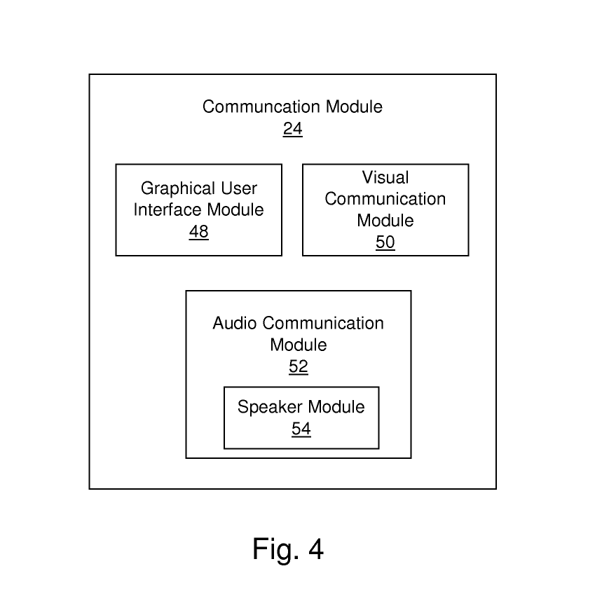

FIG. 4 illustrates a block diagram of a communication module 24 of a plant growing system 10. As illustrated, the communication module 24 comprises a graphical user interface module 48, a visual communication module 50, and/or an audio communication module 52. The audio communication module 52 includes a speaker module 54. One non-limiting example of a graphical user interface module is described by the combination of the following: a computer system control via an interface surface and a processing sensor of U.S. Pat. No. 7,118,025, issued to Silverbrook, et al.; and a method of managing a graphical user interface of U.S. Pat. No. 6,989,821 issued to Chafer et al., which are incorporated by reference for their supported teachings herein. Further, one non-limiting example of a visual communication module and an audio communication module combined in an application is described in an interactive computer controlled doll in U.S. Pat. No. 5,636,994, issued to Tong, which is incorporated by reference for its supported teachings herein. One non-limiting example of a speaker module is described in U.S. Application Publication No. 2006/0126879, by Kuo, which is incorporated by reference for its supported teachings herein. The communication module 24 includes a graphical user interface 48 which includes images of an animated plant 78. The communication module 24 further includes an audio communication module 52 configured to audibly communicate a detected level of nutrient, such as water, existing in the nutrient reservoirs, 58 and 60. In addition, the communication module 24 is configured to communicate sounds including, but not limited to: words, tones, songs, and other audio announcements to indicate a status relative to the plant 80. The status describes a possible state of the plant 80; whether it be happy, hungry, thirsty, and/or sickly so as to emulate an actual pet like a dog or cat.

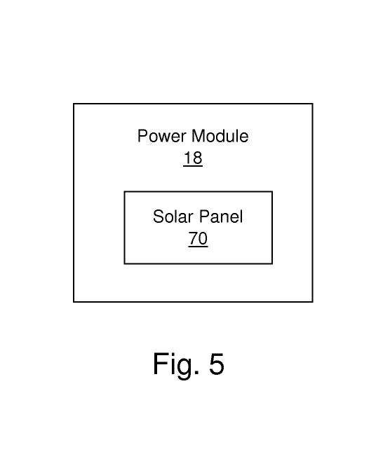

FIG. 5 illustrates a block diagram of a power module 18 of a plant growing system 10. As shown, the power module includes a solar panel 70 and in electrical communication therewith. One non-limiting example of a solar panel is described in U.S. Pat. No. 6,960,717, issued to Stuart et al., which is incorporated by reference for its supported teachings herein.

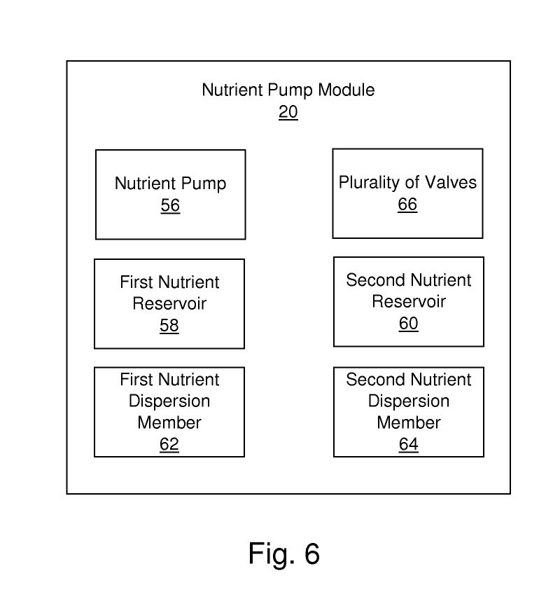

FIG. 6 illustrates a block diagram of a nutrient pump module 20 of the plant growing system 10. As illustrated, the nutrient pump module 20 comprises a nutrient pump 56 and a plurality of valves 66. One non-limiting example of a plurality of valves is described in U.S. Application Publication No. 2007/0074768, by Tuymer, which is incorporated by reference for its supported teachings herein. The illustrated nutrient pump module 20 also includes a first nutrient reservoir 58 and a second nutrient reservoir 60. One non-limiting example of a nutrient reservoir is described in U.S. Pat. No. 4,045,909, issued to Moss, which is incorporated by reference for its supported teachings herein. In addition, the nutrient pump module 20 includes a first nutrient dispersion member 62 and a second nutrient dispersion member. The nutrient pump 56 of the nutrient pump module 20 is in fluid communication with first nutrient dispersion member 62 and the second nutrient dispersion member 64 through the plurality of valves 66. The nutrient dispersion members 62, 64 are in fluid communication with the first nutrient reservoir 58 and the second nutrient reservoir 60 through the plurality of valves 66 and the nutrient pump 56. One non-limiting example of a nutrient dispersion member is described in U.S. Pat. No. 6,811,098, issued to Drechsel, which is incorporated by reference for its supported teachings herein.

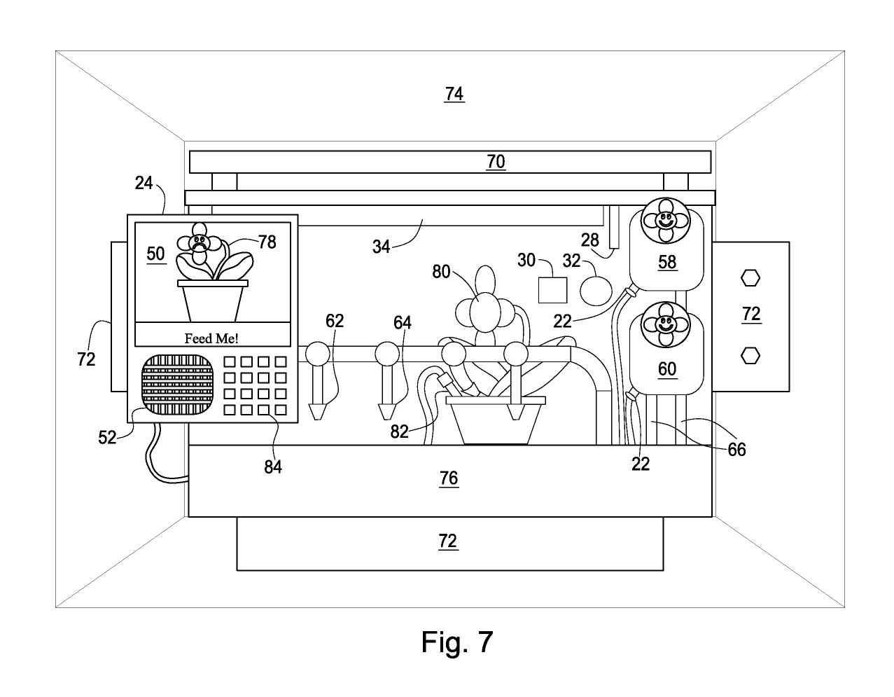

FIG. 7 illustrates a front elevational view of a plant growing system 10 disposed within a window frame 74. The illustration depicts bracket members 72 which couple the plant growing system 10 to a window frame 74. As shown, the bracket members 72 are coupled to a plant growing system housing 76. One non-limiting example of a bracket member is such as described in U.S. Pat. No. 4,771,972, issued to Shaw, which is incorporated by reference for its supported teachings herein. The illustrated plant growing system housing 76 includes a communication module 24 coupled to an exterior of the housing 76.

The illustrated plant growing system 10 additionally includes an atmospheric condition sensor module 14 including a photo sensor 28, a humidity sensor 30, and an air temperature sensor 32. The sensors 28, 30, and 32 are disposed within the plant growing system housing 76. Also shown, the plant growing system housing 76 further includes a solar panel 70 to provide and store energy. In addition, the plant growing system includes a first nutrient reservoir 58 and a second nutrient reservoir 60, each coupled to a nutrient level sensor module 68 via the control module 12. Also through the control module 12 the nutrient level sensor module 68 is coupled to a sensor probe 82 which is partially disposed in the soil of a plant 80, a first nutrient dispersion member 62, and a second nutrient dispersion member 64. Further, the illustration of the plant growing system 10 includes a lighting module 34 disposed above the plant 80.

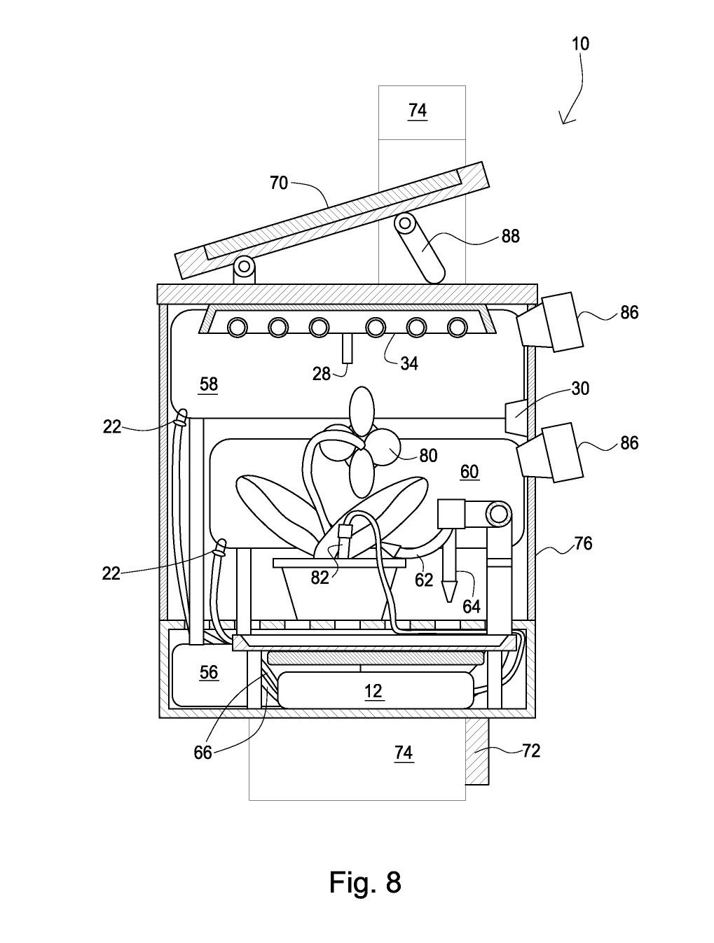

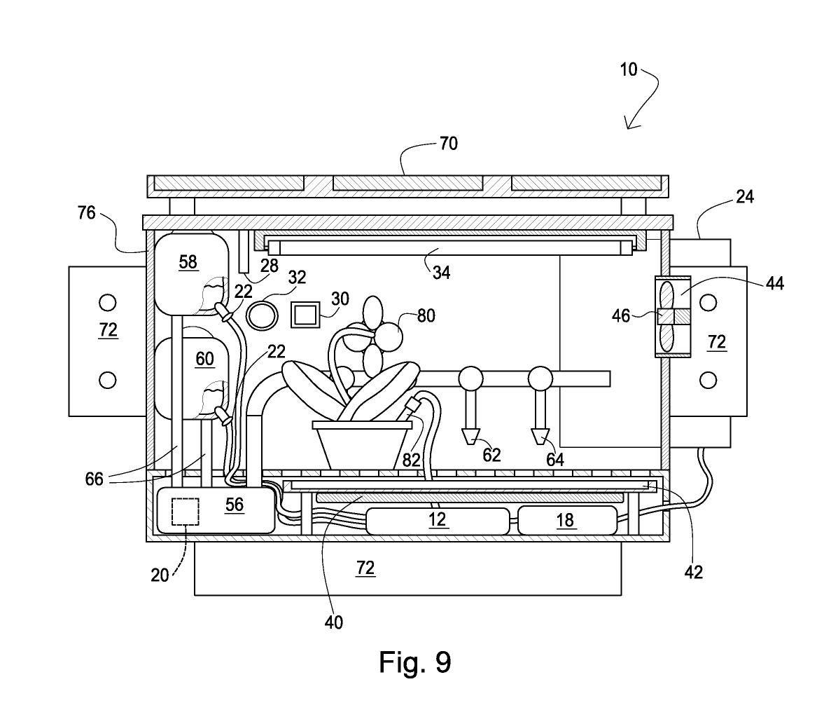

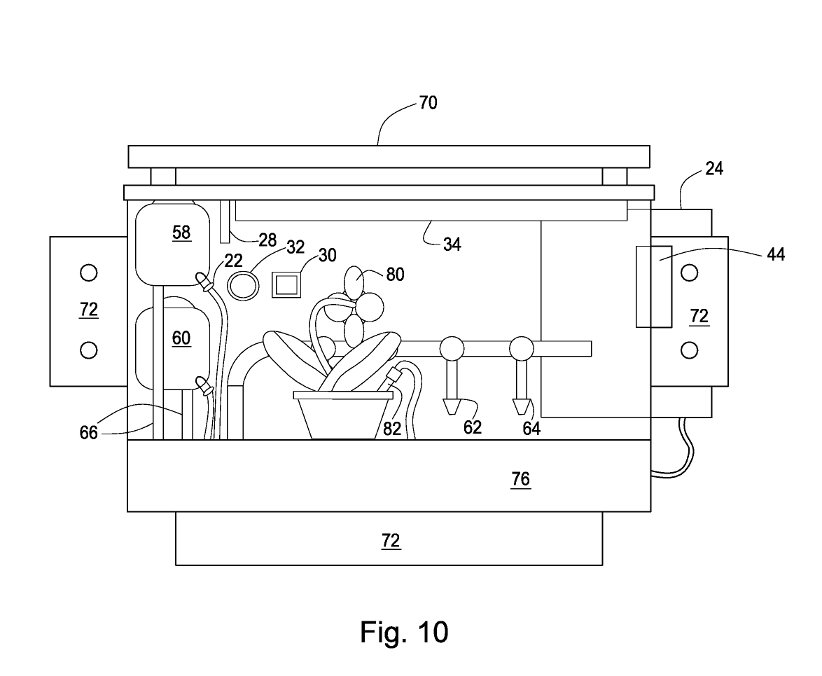

FIGS. 8, 9, and 10 illustrates a plant growing system 10 including a plant growing system housing 76, bracket members 72, a communication module 24, a solar panel 70, a first nutrient reservoir 58, a second nutrient reservoir 60, a lighting module 34, sensor probe 82, a photo sensor 28, air temperature sensor 32, humidity sensor 30, a first nutrient dispersion member 62, and a second nutrient dispersion member 64 as described and illustrated in FIG. 7. In addition, FIGS. 8 and 9 further illustrate a plant growing system including a nutrient pump module 20. The nutrient pump module 20 is coupled to a nutrient pump 56, the first nutrient reservoir 58, and the second nutrient reservoir 60. As shown, the pump 56 is coupled to the reservoirs 58, 60 through a plurality of valves 66. Further, the first nutrient reservoir 58 is coupled to the first nutrient dispersion member 62 via the nutrient pump 56, and the second nutrient reservoir 60 is coupled to the second nutrient dispersion member 64 via the nutrient pump 56. Additionally a control module 12 is illustrated in FIG. 8 which is coupled to a sensor probe 82, the nutrient pump module 20, the nutrient level sensor module 22, and the power module 18. In addition, the plant growing system 10 additionally includes a cooling module 44 and a heating module 40. The cooling module 44 is a cooling fan 46 and the heating module 40 is a heating pad 42.

In operation of one embodiment of a plant growing system 10, a user may couple the plant growing system 10 to a window frame 74. For example, a user may arrange a set of bracket members 72 to couple the plant growing system housing 76 to a window frame 74. When the housing 76 is securely coupled to the window frame 74, a user may then couple a power module 18 to a power source. The power module 18 may be additionally coupled to a solar panel 70, to store and provide energy to the power module 18. Further, a user may orient the solar panel 70 which includes an adjustable hinge so as to angle the solar panel 70 towards a light source. A user may place a plant 80 within the plant growing system 10 to grow. Then a user may insert the nutrient sensor probe 82 into soil surrounding the plant 80, to monitor the nutrient level of the plant.

In further operation of one embodiment of a plant growing system 10, a photo sensor 28, air temperature sensor 32, and humidity sensor 30 each respectively monitor the light level, air temperature level, and humidity level surrounding the plant 80 disposed within the plant growing system 10. Under varying conditions the photo sensor 28 enables the lighting source to either increase or decrease the amount of light that the plant receives so as to generate optimal growing conditions for the species of the plant 80 contained within the system 10. In addition, the air temperature sensor 32 determines the temperature within the system 10 such that the temperature feedback enables proper control of the temperature conditions within the plant growing system 10. Based on feedback from the temperature sensor 32 the air temperature is modulated via the control module 12 which enables cooling by the cooling fan 46 of the cooling module 44, or enables heating by the heating pad 42 of the heating module 40. Furthermore, the humidity sensor 30 monitors the precipitation in the atmosphere about the plant 80. The control module 12 controls the different modules of the plant growing system 10 through electronic and/or wireless signal communication. Accordingly, the plant growing system 10 utilizes the control module 12 to control and facilitation communication between the modules which include: an atmospheric condition sensor module 14, an atmospheric condition response module 16, power module 18, nutrient pump module 20, nutrient level sensor module 22, communication module 24, nutrient concentration sensor probe module 26, humidifying module 36, dehumidifying module 38, lighting module 34, heating module 40, cooling module 44, graphical user interface module 48, visual communication module 50, audio communication module 52, and a speaker module 54.

In still further operation of one embodiment of the plant growing system 10, the system includes a first nutrient reservoir 58 and second nutrient reservoir 60 which store nutrients for a plant 80. The nutrient reservoirs 58, 60 are each coupled to a nutrient level sensor module 22, which monitors the amount of nutrients within each of the nutrient reservoirs 58, 60. The nutrient level sensor modules 22 are in electronic communication with the control module. The first reservoir 58 is coupled to the first nutrient dispersion member 62 via the nutrient pump 56, and the second nutrient reservoir 60 is coupled to the second nutrient dispersion member 64 via the nutrient pump 56. Also, the nutrient dispersion members 62, 64 are in fluid communication with the nutrient reservoirs 58, 60 by the nutrient pump 56. The sensor probe 82 monitors the nutrients, water and mineral concentrations, within the soil of a plant 80. The control module 12 controls the nutrient pump 56, to pump nutrients from the nutrient reservoirs 58, 60 through the nutrient dispersion members 62, 64 to the plant 80. Furthermore, a fill aperture 86 allows a user to refill the nutrient reservoirs 58, 60 when the nutrient reservoirs 58, 60 have minimal and/or no remaining nutrient fluid.

The plant growing system provides several advantages compared to the other plant growing systems known in the art. An advantage of the plant growing system is the effortless care and maintenance that is required to operate and maintain the plant growing system 10. The system includes everything that is necessary to grow a plant, thus being an all-in-one plant growing system. The system is configured to include all the necessary functions and materials to grow a plant, with little or no maintenance. Furthermore, the communications module includes a graphical user interface that is configured to communicate to a user the status of the plant, so that the plant can be much like a pet.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, the figures illustrate a plant growing system 10 comprising a communication module 24, an audio communication module 52, a control module 12, an atmospheric condition sensor module 14, an atmospheric condition response module 16, a power module 18, a nutrient pump module 20, a nutrient concentration sensor probe module 26, a nutrient level sensor module 22, a lighting module 34, a humidifying module 36, a dehumidifying module 38, a heating module 40, a cooling module 44, a graphical user interface module 48, a visual communication module 50, and a speaker module 54, and one skilled in the art would appreciate that the modules may be disposed anywhere within and/or about the plant growing system housing and still perform their intended functions.

Similarly, although the figures illustrate a solar panel 70 disposed on top of the plant growing system housing 76, one skilled in the art would appreciate that the solar panel may be coupled to the plant growing system housing anywhere relative to receiving sunlight and still perform its intended function. Further, the figures although illustrate that a photo sensor 28, air temperature sensor 32, and humidity sensor 30 are disposed in the plant growing system housing 76, one skilled in the art would appreciate that the components of the plant growing system may be disposed anywhere within the plant growing system housing and still perform their intended functions.

It is also envisioned that although the lighting module 34 is disposed above the plant, one skilled in the art would appreciate that the lighting module may be disposed anywhere along the plant growing system 10 and still perform its intended function. Furthermore, one skilled in the art would appreciate that the first and second nutrient reservoirs 58, 60, nutrient pump 56, nutrient dispersion members 62, 64, and sensor probe 82 may be disposed anywhere within the plant growing system 10 and still perform their intended functions. The cooling fan 46 and/or heating pad 42 may be disposed anywhere along the plant growing system housing 76 and still perform their intended functions. In addition, the plant growing system housing 76 is illustrated coupled to a window frame 74, one skilled in the art would appreciate that the plant growing system housing may be disposed anywhere relative to direct sunlight and still perform its intended function.

It is expected that there could be numerous variations of the design of this invention. For example, the plant growing system housing 10 may vary in size, shape, configuration, design, color, orientation and still perform its intended function. Furthermore, the figures illustrate a bracket member 72 configured to secure and support the plant growing system 10 to a window frame 74. Examples of a bracket member may include, but are not limited to: a clip attachment, a suction attachment, an adhesive attachment, an anchor-type attachment, a hook attachment, a latch attachment, a clamp attachment, a toggle bolt attachment and/or a hanging attachment.

While one embodiment of the invention is described wherein a housing is coupled to/through a window, it is envisioned that a housing may be placed on a plant stand.

Finally, it is envisioned that the components of the device, such as the adjustment members 88, bracket members 72, fill aperture 86, the plurality of valves 66, and the plant growing system housing 76 may be constructed of a variety of materials. Some non-limiting examples of the variety of materials may be: plastic, rubber, rubber composition, plastic compositions, glass, metal, metal alloys, ceramics and/or composites of any of the above mentioned materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A plant growing system for growing plants, comprising:
a control module, configure to provide control;
an atmospheric condition sensor module, in communication with the control module, configured to sense an atmospheric condition;
an atmospheric condition response module, in communication with the control module, and in communication with the atmospheric condition sensor module, configured to provide a response to an atmospheric condition;
a nutrient concentration sensor probe module, in communication with the control module, configured to detect a nutrient concentration in soil; and
a nutrient pump module, in communication with the control module, and in communication with the nutrient concentration sensor probe module, configured to pump a nutrient.

2. The plant growing system of claim 1, wherein the atmospheric condition sensor module comprises one or more sensors selected from the group consisting of: a photo sensor, a humidity sensor, and an air temperature sensor; and wherein the atmospheric condition response module comprises one or more modules selected from the group consisting of: a lighting module, a humidifying module, a dehumidifying module, a heating module, and a cooling module.

3. The plant growing system of claim 2 wherein the heating module comprises a heating pad.

4. The plant growing system of claim 2, wherein the cooling module comprises a fan.

5. The plant growing system of claim 1, further comprising:
a water level sensor module, in communication with control module, and in communication with the pump module, configured to sense a level of water; and
a communication module, in communication with the control module, and in communication with the water level sensor module, configured to communicate a detected level of water.

6. The plant growing system of claim 5, wherein the communication module comprises an audio communication module, configured to audibly communicate a detected level of water.

7. The plant growing system of claim 5, wherein the communication module comprises a graphical user interface module, configured to provide a graphical user interface for communication.

8. The plant growing system of claim 7, wherein the graphical user interface module comprises an animated plant; and wherein sensor module data is reflected by an appearance of the animated plant.

9. The plant growing system of claim 1, wherein the nutrient pump module comprises:
a first nutrient reservoir, configured to store a first nutrient;
a nutrient pump, in fluid communication with the first nutrient reservoir, configured to pump a nutrient; and
a first nutrient dispersion member, in fluid communication with the nutrient pump, configured to disperse the first nutrient from the first nutrient reservoir to a plant.

10. The plant growing system of claim 9, wherein the nutrient pump module further comprises:
a second nutrient reservoir, in fluid communication with the nutrient pump, configured to store a second nutrient; and
a second nutrient dispersion member, in fluid communication with the nutrient pump, configured to disperse the second nutrient from the second nutrient reservoir to a plant.

11. The plant growing system of claim 1, further comprising a power module, in communication with the control module, configured to provide energy.

12. The plant growing system of claim 11, wherein the power module comprises a solar panel.

13. The plant growing system of claim 1, further comprising:
a plant growing system housing, configured to house the plant growing system; and
a bracket member, coupled to the plant growing system housing, coupleable to a window frame, configured to couple the plant growing system housing to a window frame.

14. A plant growing system for growing plants, comprising:
a control module, configure to provide control;
an atmospheric condition sensor module, in communication with the control module, configured to sense an atmospheric condition;
an atmospheric condition response module, in communication with the control module, and in communication with the atmospheric condition sensor module, configured to provide a response to an atmospheric condition;
a nutrient concentration sensor probe module, in communication with the control module, configured to detect a nutrient concentration in soil; and
a nutrient pump module, in communication with the control module, and in communication with the nutrient concentration sensor probe module, configured to pump a nutrient;
wherein the atmospheric condition sensor module comprises one or more sensors selected from the group consisting of: a photo sensor, a humidity sensor, and an air temperature sensor; and wherein the atmospheric condition response module comprises one or more modules selected from the group consisting of: a lighting module, a humidifying module, a dehumidifying module, a heating module, and a cooling module.

15. The plant growing system of claim 13, further comprising:
a water level sensor module, in communication with control module, and in communication with the pump module, configured to sense a level of water; and
a communication module, in communication with the control module, and in communication with the water level sensor module, configured to communicate a detected level of water.

16. The plant growing system of claim 15, further comprising:
a plant growing system housing, configured to house the plant growing system; and
a bracket member, coupled to the plant growing system housing, coupleable to a window frame, configured to couple the plant growing system housing to a window frame.

17. A plant growing system for growing plants, comprising:
a control module, configure to provide control;
an atmospheric condition sensor module, in communication with the control module, configured to sense an atmospheric condition;
an atmospheric condition response module, in communication with the control module, and in communication with the atmospheric condition sensor module, configured to provide a response to an atmospheric condition;
a nutrient concentration sensor probe module, in communication with the control module, configured to detect a nutrient concentration in soil;
a nutrient pump module, in communication with the control module, and in communication with the nutrient concentration sensor probe module, configured to pump a nutrient;
a plant growing system housing, configured to house the plant growing system; and
a bracket member, coupled to the plant growing system housing, coupleable to a window frame, configured to couple the plant growing system housing to a window frame.

18. The plant growing system of claim 17, wherein the atmospheric condition sensor module comprises one or more sensors selected from the group consisting of: a photo sensor, a humidity sensor, and an air temperature sensor; and wherein the atmospheric condition response module comprises one or more modules selected from the group consisting of: a lighting module, a humidifying module, a dehumidifying module, a heating module, and a cooling module.

19. The plant growing system of claim 18, further comprising:
a water level sensor module, in communication with control module, and in communication with the pump module, configured to sense a level of water; and
a communication module, in communication with the control module, and in communication with the water level sensor module, configured to communicate a detected level of water.

20. The plant growing system of claim 19, wherein the communication module comprises an audio communication module, configured to audibly communicate a detected level of water; and wherein the audio communication module comprises a speaker module.
